(19) United States
(12) Patent Application Publication
(10) Pub. No.: US 2003/0098564 A1
(43) Pub. Date: May 29, 2003

(54) Independent suspension system for light and medium duty vehicles

(76) Inventors: Ervin VanDenberg, Massillon, OH (US); David H. Croston, Navarre, OH (US)

Correspondence Address: SAND & SEBOLT, Suite 1100, Aegis Tower, 4940 Munson Street NW, Canton, OH, 44718-3615, US

(21) Appl. No.: 09/996,496

(22) Filed: Nov. 29, 2001

(51) Int. Cl. B60G 9/04

(52) U.S. Cl. 280/124.157

(57) ABSTRACT

The present invention relates to an improved vehicle suspension system. More particularly, the present invention relates to an independent suspension system for light and medium duty trailers which utilizes a flexible bladder mounted between the vehicle frame and the axle. The flexible bladder is housed within a casing to control the flow of air into the bladder and to provide for flexible movement of the axle relative to the vehicle frame. In the preferred embodiment, the flexible bladder is a traditional break-chamber housing and multiple break-chamber housings may be utilized to increase the load-carrying capacity of the trailer.

### BACKGROUND OF THE INVENTION

1. Technical Field

The invention relates generally to an improved vehicle suspension system. More particularly, the invention relates to an improved vehicle suspension system for use with light and medium duty trailers. More specifically, the invention relates to a suspension system for light and medium duty trailers which utilizes enclosed diaphragms to provide vertical support between the trailer and the axle.

2. Background Information

The trucking industry has witnessed a dramatic increase in the costs associated with transporting goods. Additionally, there has been on increase in the sale of pickup style trucks and sport utility vehicles assuring that a much broader range of people have vehicles with the capacity to pull light and medium duty trailers. The need to pull light and medium duty trailers has also increased with the associated increase in the growth of small businesses throughout the world. These changes in the trucking industry, and in the number of people interested in purchasing and subsequently using light and medium duty trailers necessitates the need for an efficient and relatively inexpensive suspension system for use on light and medium duty trailers.

Suspension systems may take a variety of forms, including parallelogram suspensions and leading and trailing beam type suspensions, any of which may utilize either mechanical springs, air springs or a combination of both mechanical springs and air springs. In the past, light and medium duty trailers often utilized mechanical springs and/or torsion tubes as a way of taking up the necessary movement between the axle and the trailer frame while supporting the vertical loads associated with the trailer. Mechanical springs often took the form of coil leaf springs, variations on sear springs, and coil springs.

Additionally, torsion tubes were often utilized and often took the form of an axle with one or more rubber components whereby movement of the axle relative to the trailer was taken up by twisting or deflecting the rubber components. While these method of operation were presumably adequate for the purpose for which they were intended, they do not provide the smooth even ride of an air type suspension system, and also do not provide for load leveling characteristics commonly associated with air type suspension systems. While air type suspension systems have been contemplated for light and medium duty trailers, the cost of such systems has been somewhat high when compared to the limited cost of light and medium duty trailers and as such, have never gained wide acceptance.

A number of the problems associated with air ride suspension systems on light and medium duty trailers include the cost of the air spring and the necessary mechanical linkages to control the movement of the air spring. These costs are relatively high compared to existing mechanical style suspension systems. Additionally, air springs, or air bladders, support vertical load and provide a dampening between the axle and the trailer frame. However, air bladders themselves provide no resistance lateral and longitudinal deflection and therefore must be artificially stabilized by mechanical linkages extending between the axle and the frame to isolate the air spring and assure that the air spring provides only vertical support and dampening. These linkages coupled with relatively high initial cost and replacement cost of air springs made air ride suspension systems for light and medium duty trailers too costly for widespread acceptance.

The need thus exists for an air ride suspension system for light and medium duty trailers which provides for an air bladder which is stable and which adequately provides a dampening force between movement of the axle relative to the trailer frame while simultaneously supporting the vertical load associated with the trailer.

### SUMMARY OF THE INVENTION

Objectives of the invention include providing an air ride suspension system for light and medium duty trailers. This and other objectives of the invention are obtained by the improved vehicle suspension system, the general nature of which may be stated as including a suspension system for use with a vehicle having a frame and a tire wheel assembly comprising a suspension frame rail, at least one flexible bladder mounted to the frame rail and adapted to be mounted adjacent each side of the frame, at least one torque bar extending adjacent to the suspension frame rail, a flexible bladder being operatively connected to the torque bar, and a spindle adapted to receive a tire wheel assembly attached to the torque bar whereby movement of the spindle is reacted by the flexible bladder. This objective is also carried out by a method of supporting a load on a vehicle comprising the steps of providing a vehicle with a frame and a pair of tire wheel assemblies, applying a force either upwardly or downwardly on the tire wheel assemblies, transferring the force from the tire wheel assembly into a torque rod, rotating the torque rod as a result of the force, and reacting the torque rod in at least one brake chamber mounted to the frame.

### BRIEF DESCRIPTION OF THE DRAWINGS

The preferred embodiment of the invention, illustrative of the best mode in which applicant contemplated applying the principles, is set forth in the following description and is shown in the drawings and is particularly and distinctly pointed out and set forth in the appended claims.

FIG. 1 is a side elevational view of a truck and trailer with a suspension system applied to the trailer;

FIG. 2 is a cutaway view of the trailer shown in FIG. 1 with portions shown in dot dash lines to expose the underlying suspension system;

FIG. 3 is a rear elevational view of the trailer shown in FIG. 1 with portions cut away;

FIG. 4 is a front perspective view of the suspension system of the present invention;

FIG. 5 is a rear perspective view of the suspension system of the present invention;

FIG. 6 is a top plan view of the suspension system of the present invention;

FIG. 7 is a bottom plan view of the suspension system of the present invention;

FIG. 8 is a side elevational view of the suspension system of the present invention with portions cut away and shown in section;

FIG. 9 is a side elevational view similar to that shown in FIG. 8 and shown in the lowest operable position;

FIG. 10 is a side elevational view similar to FIG. 9 shown with a suspension system in the upper most operable position; and

FIG. 11 is a front elevational view of a second embodiment of the present invention.

Similar numerals refer to similar parts throughout the drawings.

### DESCRIPTION OF THE PREFERRED EMBODIMENTS

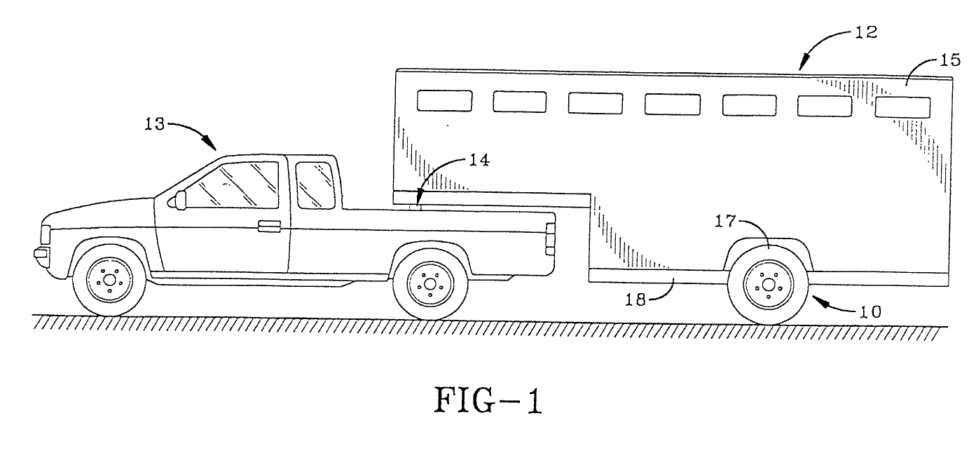

The improved vehicle suspension system of the present invention is indicated generally at 10 mounted on a trailer 12 being pulled by a tow vehicle 13. Tow vehicle 13 and trailer 12 may be interconnected by a variety of mechanical connections including a bumper pull hitch, a fifth wheel hitch or a gooseneck hitch such as the one shown in FIG. 1 and indicated generally at 14. Generally tow vehicle 13 and trailer 12 are attached mechanically as described above and also electronically so that operation of the various electrical systems such as brake lights, back up lights and running lights may be operated on the trailer as these systems are operated on the truck.

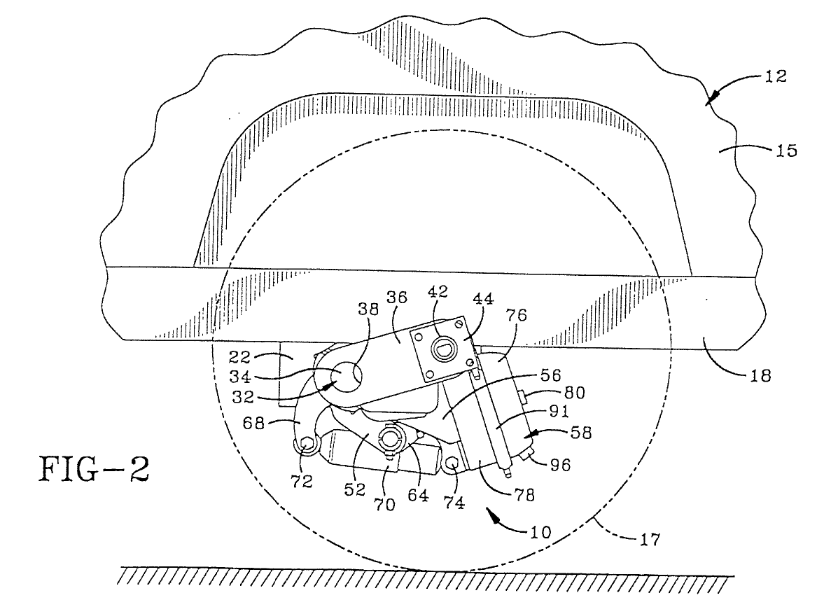

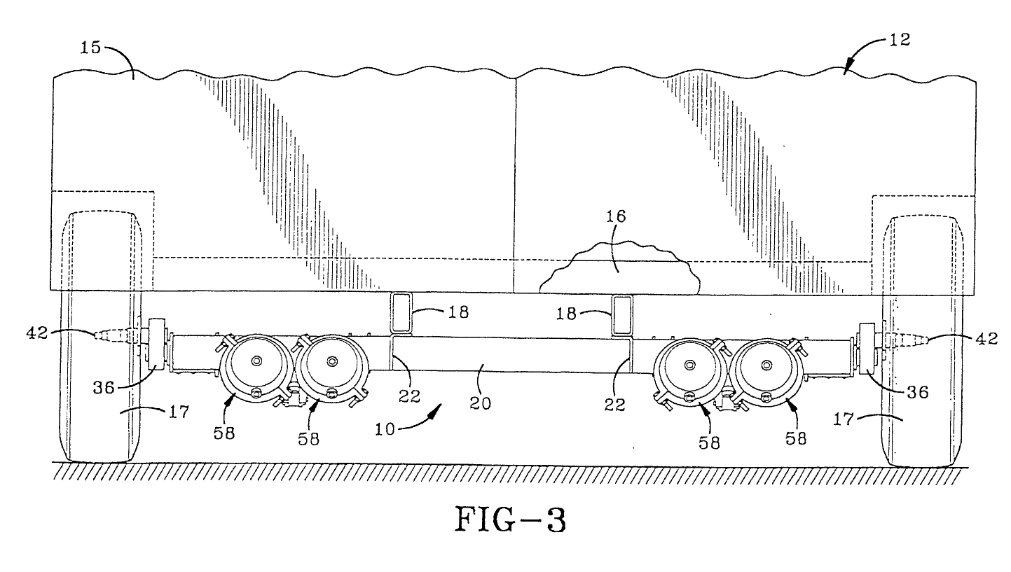

Referring more particularly to FIGS. 2 and 3, trailer 12 includes a cargo box 15 having a pair of cross support members 16 mounted beneath box 15 as well as at least one pair of tire wheel assemblies 17. Trailer 12 may also include a plurality of support beams 18 extending at various locations along the length of trailer 12.

In accordance with the present invention, suspension system 10 includes a frame rail 20 extending substantially across the width of trailer 12. Frame rail 20 may take a variety of cross-sectional configurations including round, square and rectangular. The beam is shown as square in the present description, but may take other configurations without departing from the spirit of the present invention. Frame or frame rail 20 includes a pair of angle brackets 22. Angle bracket 22 are parallel and spaced apart a distance substantially equal to the distance between support beams 18. Angle brackets 22 include a plurality of mounting holes 24 to accept bolts for bolting suspension system 10 to trailer 12. Additionally, angle brackets 22 may take a variety of configurations depending on the particular trailer to which the suspension system is to be mounted. Trailers may have a variety of configurations each of them somewhat different based on the use of the trailer, and the manufacturer of the trailer. Angle brackets 22 are simply manufactured to provide the most expedient mounting method to a given trailer 12 and may be varied accordingly without departing from the spirit of the present invention.

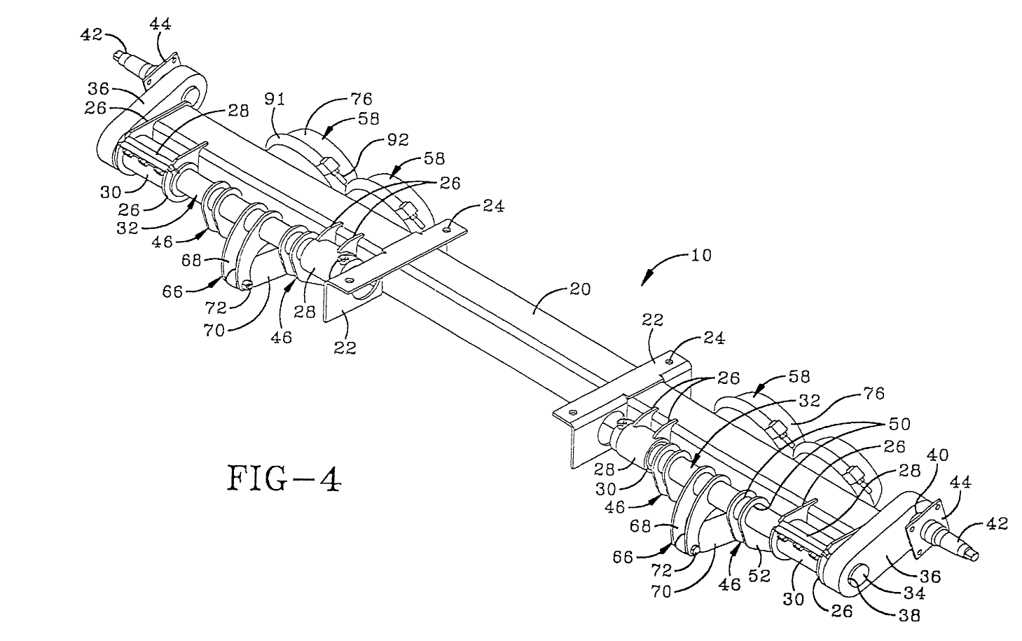

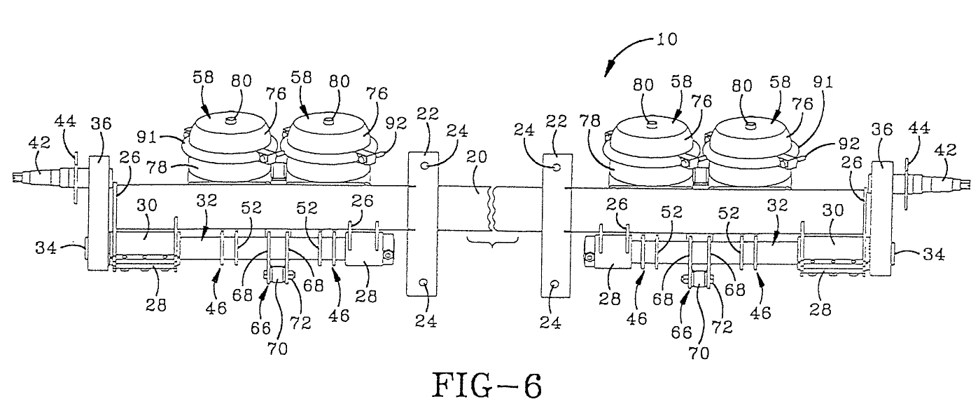

Referring then to FIGS. 2-7, a plurality of bearing brackets 26 extend outwardly from the front of frame 20. Bearing brackets 26 are each welded to the outer casing 28 of a bearing 30. Each bearing 30 includes a through aperture sized to receive a torque bar 32. Torque bar 32 extends through each bearing 30 such that torque bar 32 is rotatably supported in bearings 30 by way of bearing brackets 26 such that the weight of torque bar 32 is ultimately carried by frame 20.

Torque bar 32 includes an outer end 34 having a spindle lever 36 mounted thereon. Spindle lever 36 is formed with a first hole 38 complementarily shaped to outer end 34 of torque bar 32 such that when spindle lever 36 is placed over the edge of outer end 34 of torque bar 32 and is mounted thereon. Spindle lever 36 is also formed with a second hole 40 sized to receive a spindle 42. Spindle 42 may have a variety of configurations, but in the present invention, extends through second hole 40 formed in spindle lever 36 and also includes a mounting plate 44 for retaining a brake assembly (not shown). Referring more particularly to FIG. 3, spindle 44 and tire wheel assembly 17 are mounted onto spindles 42 to provide rotational movement of spindle 42 and tire wheel 17 relative to trailer 12.

In accordance with another feature of the present invention, two spaced apart mounting devises 46 are mounted onto torque bar 32 intermediate bearings 30. Each mounting clevis 42 includes a pair of spaced apart arms 48 having an aperture 50 formed therethrough. Each mounting clevis 46 includes a lower arm 52 whereby arms 48 of lower arm 52 define a space 54 therebetween.

A large mounting bracket 56 is mounted to the front of frame 20 and supports a diaphragm chamber assembly 58 by way of mounting bolts 60. Diaphragm chamber assembly 58 includes a push rod 62 having a pivot clevis 64 mounted on the free end thereof. Pivot clevis 64 extends intermediate lower arms 52 into space 54 and is mounted thereto by any convenient mounting means such as a mounting pin or bolt. The operation of diaphragm chamber assembly push rod 62 and pivot clevis 64 will be described in more detail hereinbelow.

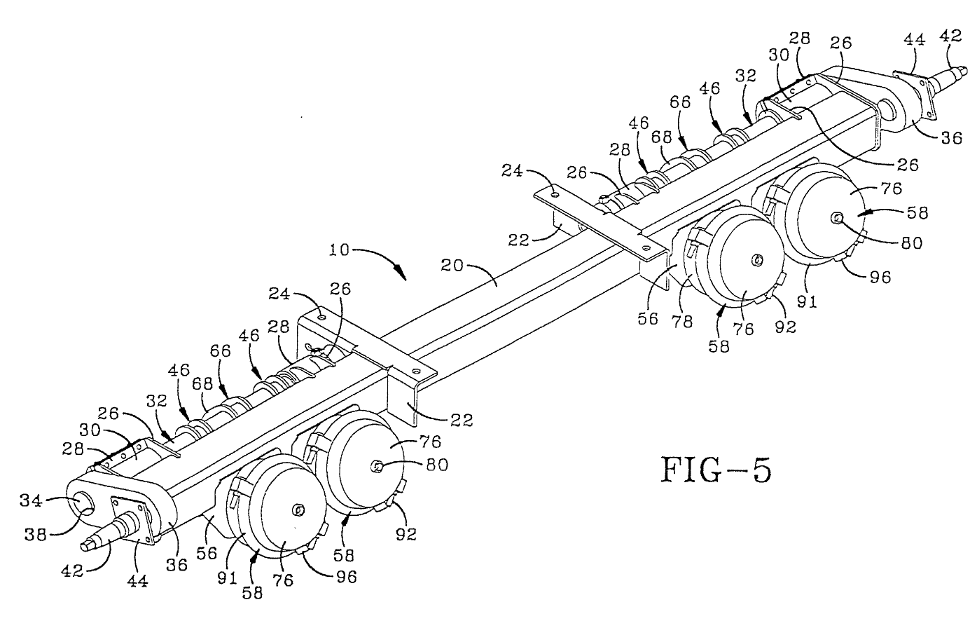

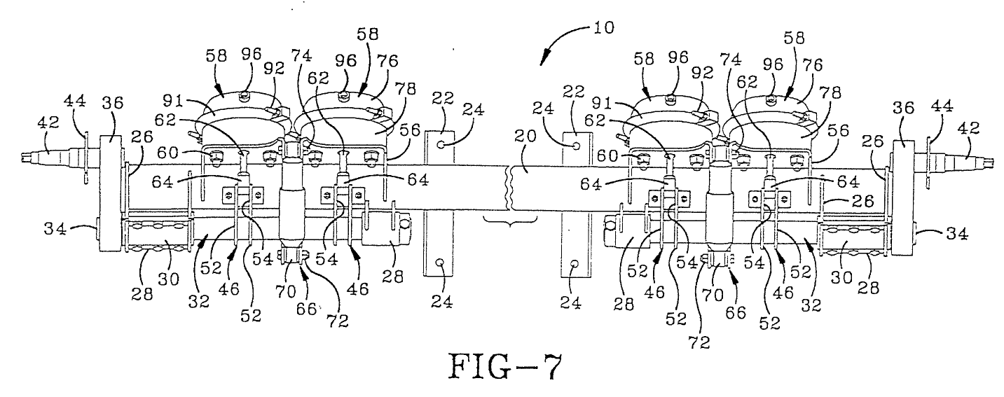

As is evident from FIGS. 5-7, a large mounting bracket 56 is provided adjacent each mounting clevis 46 for supporting an associated diaphragm chamber assembly 58 and for receiving an associated push rod 62. Referring to FIG. 7, suspension system 10 is shown having a pair of diaphragm chamber assemblies 58 mounted to each side of frame 20 providing a total of four mounting chambers for tire wheel assembly 17 mounted on spindles 42. Referring again to FIGS. 2-7, a central clevis 66 is shown attached to torque bar 32 intermediate mounting devises 46. Central clevis 66 is secured to torque bar 32 by any convenient mounting means such as welding, and includes a pair of parallel and spaced apart mounting arms 68. Mounting arms 68 are spaced apart and sized to receive a first end of a shock absorber 70. Shock absorber 70 is mounted to mounting arm 68 by way of a bolt 72 and extends upwardly between large mounting brackets 56 and is mounted thereto via a bolt 74. Shock absorber 72 provides a force dampening when tire wheel assembly 17 are moving on extremely rough terrain, or driving at high speeds over uneven pavement and during normal operation to reduce the reactionary effects of diaphragm chamber assemblies 58.

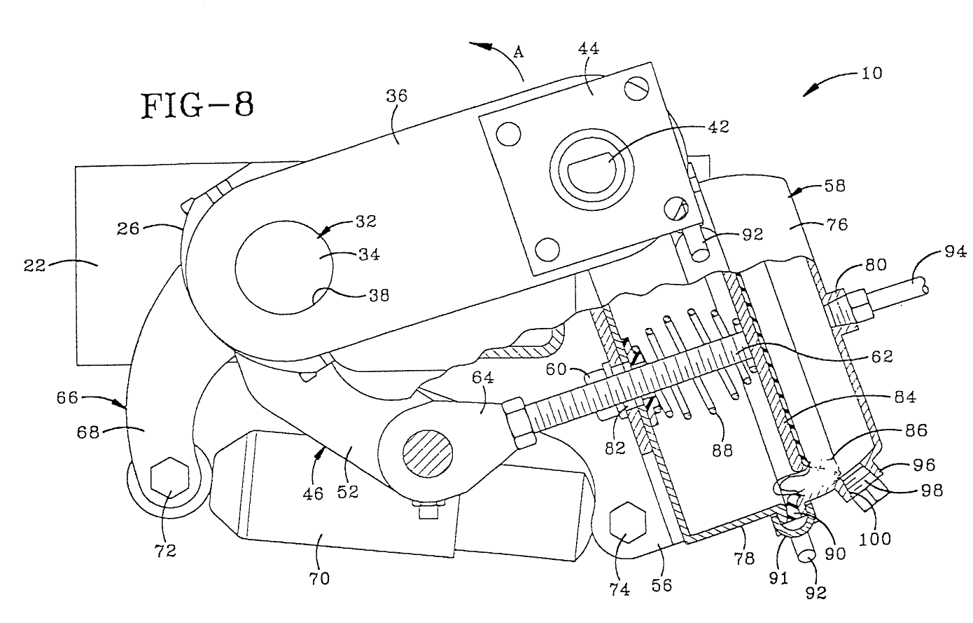

Referring specifically to diaphragm chamber assembly 58, and looking more particularly at FIG. 8, diaphragm chamber assembly 58 includes an upper chamber 76 and a lower chamber 78 with both upper and lower chambers 76 and 78 being formed with a central aperture 80 and 82 respectively. As described above, push rod 62 is formed on one end with a pivot clevis 64 with the other end being mounted to a bladder plate 84. Bladder plate 84 is then positioned adjacent to the central portion of a flexible bladder 86. Flexible bladder 86 may take a variety of configurations, but in the preferred embodiment is a fiber reinforced rubber similar to that out of which rolling lobe air springs are manufactured. A coil spring 88 is mounted intermediate lower chamber 76 and bladder plate 84 to provide constant pressure against bladder plate 84 as may be required during operation.

In assembly, flexible bladder 86 includes a central portion as discussed above bearing against bladder plate 84 and an annular ridge 90 sandwiched between upper chamber 76 and lower chamber 78 during assembly. A clamp ring 91 is then positioned around annular ridge 90, upper chamber 76 and lower chamber 78 and is compressed by way of bolts 92. As bolts 92 are tightened, ring 91 becomes smaller and compresses upper chamber 76, lower chamber 78 and annular ridge 90 to secure an airtight arrangement. Central aperture 80 of upper chamber 76 is sized to receive a threaded attachment to secure air line 94 which is attached to any usual source of compressed air carried by the trailer 12, such as a compressor. Additionally, a second side aperture 96 is sized to receive a threaded input 98 which may provide an air outlet through hole 100.

As can be seen from our description of FIG. 8, and more particularly in accordance with the invention, diaphragm chamber assembly 58 and the elements associated therewith may take a variety of configurations without departing from the spirit of the present invention, but in accordance with the preferred embodiment of the invention, form a brake chamber such as those traditionally utilized with tractor trailer type air brakes. Diaphragm chamber assembly 58 provides a stabilized air bellows for dampening movement between spindles 42 and cargo box 15 while simultaneously supporting the vertical weight of trailer 12.

Operationally, and referring specifically to FIG. 8, air is provided through air input 94 from a usual source such as a compressor carried on trailer 12 such that air traveling through input 94 will flood upper chamber 76 with air at approximately 70-110 lbs. per square inch. Tire wheel assembly 17 is mounted onto spindle 42 as the weight of trailer 12 acts on tire wheel assembly 42, tire wheel assembly 17 will push upwardly on spindle 42 applying a rotational force in the direction of arrow A (FIG. 8) onto spindle lever 36. In as much as spindle lever 36 is rigidly attached to torque bar 32, torque bar 32 will attempt to rotate as a result of force applied through spindle 42 in the direction of arrow A. However, torque bar 32 will resist rotation as a result of its interconnection to flexible bladder 86 in the following manner. Extending between torque bar 32 are a pair of mounting devises 46 attached respectively to a pivot clevis 64, a push rod 62 bearing directly against bladder plate 84 and ultimately flexible bladder 86. As torque bar 32 attempts to rotate in the direction of arrow A, such rotation will be resisted by the approximate 90 lbs. per square inch of pressure acting against flexible bladder 86 which resistance will pass through flexible bladder 86 to bladder plate 84 through push rod 62 into pivot clevis 64 and ultimately into mounting clevis 46 which is rigidly attached to torque bar 32. As can be seen, when trailer 12 is at rest, motion of spindle 42 in the direction of arrow A is counteracted by the air pressure acting against flexible bladder 86 inside diaphragm chamber assembly 58.

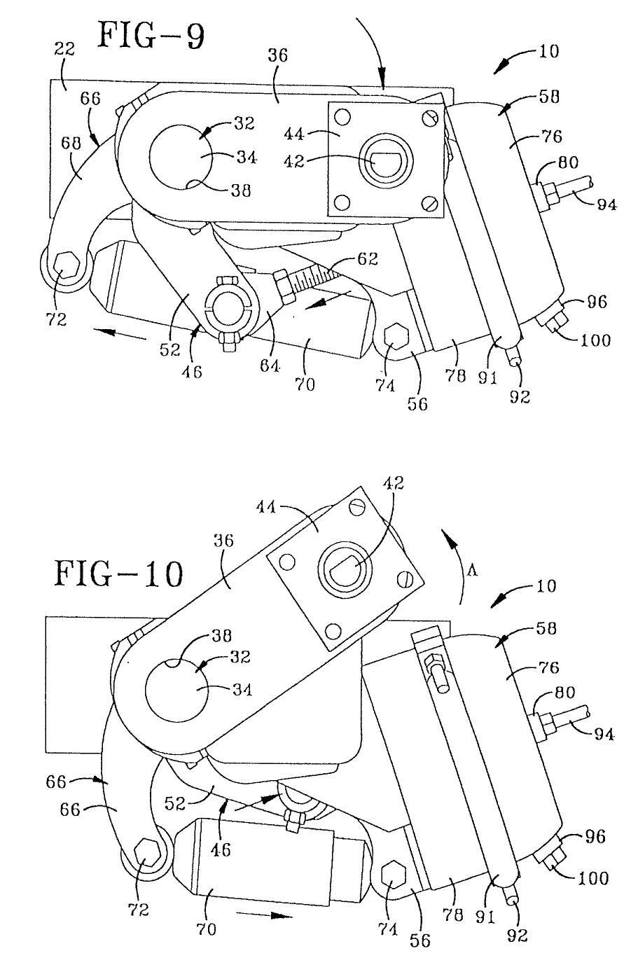

However, as the vehicle is in motion, tire wheel assembly 17 and spindle 42 will move through a range of motion to take up irregularities in the road surface and to stabilize trailer 12 from a variety of forces including lateral forces, longitudinal forces, brake reactivity, diagonal axle walk, and roll about the longitudinal axis. More particularly, and referring specifically to FIG. 9, if tire wheel assembly 17 associated with spindle 42 were to suddenly drop, for example, into a pothole or off of a curb, flexible bladder 86 would be permitted to expand as significantly less force would be acting through push rod 62 into bladder plate 84. As can be seen more specifically from FIG. 9, flexible bladder 86 moves into lower chamber 78 and push rod 62 moves towards the front of the vehicle all in response to the downward movement of spindle 42.

Conversely, when tire wheel assembly 17 mounted on spindle 42 encounters a bump, or attempts to drive over a curb, tire wheel assembly 17 will move upwardly, which upward movement will cause rotation in the direction of arrow A thereby substantially rotating torque bar 32 and causing the movement of mounting clevis 46 and push rod 62 into upper chamber 76 thereby substantially reducing the volume of air in diaphragm chamber assembly 58 as a result of the movement of flexible bladder 86 to substantially increase the pressure above flexible bladder 86. The movement from the positions shown in FIG. 8 and in FIG. 10 are also controlled by way of the movement of shock absorber 70 to slow the rate of reactivity inside diaphragm chamber assembly 58. Additionally, air outlet 100 may be utilized to connect multiple diaphragm chamber assemblies 58 together when on a common side of the vehicle, such as in a daisy chain fashion.

As is also evident from the description of the preferred embodiment, a number of variations of the invention may be provided without departing from the spirit of the present invention. Additionally, the suspension system of the present invention provides a number of benefits, including that the system may be preassembled and easily installed to an existing trailer during manufacture or may be retrofitted to an existing trailer as a single unit. Still further, the suspension system utilizes independent wheel suspension and is therefore extremely roll stable. Still further, single, tandem or tri-axle trailers may all utilize the invention and when multiple axles are utilized on a single trailer to increase load carrying capacity, diaphragm chamber assemblies 58 may be detached together by attaching air hoses from a first outlet 100 of a first chamber to an inlet of a second chamber on a second axle to provide axle to axle load equalization. Still further, the suspension system 10 provides a constant ride height and will not sag under load which is a feature that has not been found true with mechanical systems. Still further, because of the compact nature of the present invention, a lower trailer floor is generally realized which substantially aids in loading and unloading the trailer. Additionally, brake chambers are provided in varying sizes having varying vertical lift capacities and as such, brake chambers having the load carrying characteristics of suspension system 10 may be tailored by altering the size, and consequently the load carrying capability of diaphragm chamber assemblies 58.

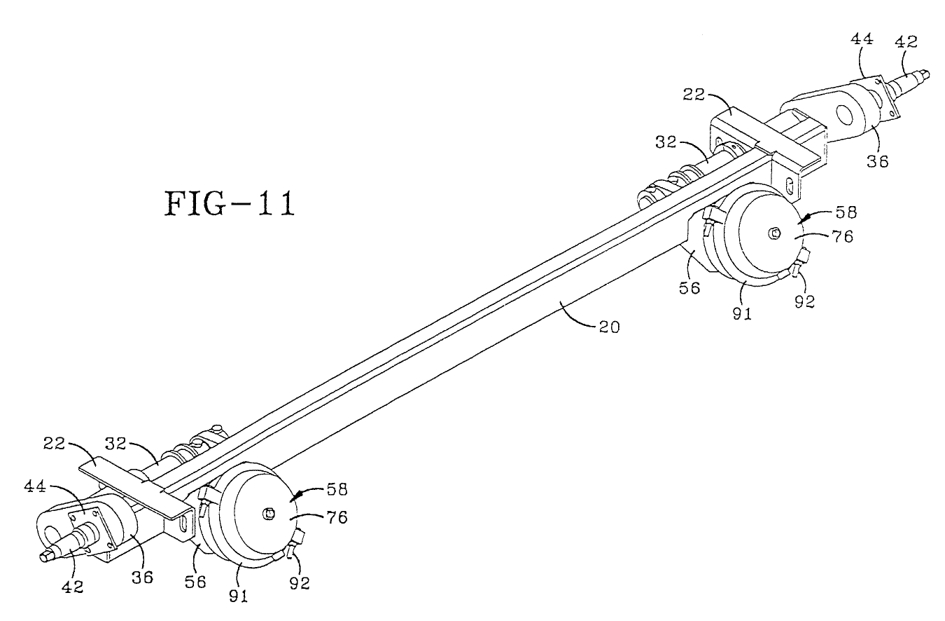

In the drawings described above, two diaphragm chamber assemblies 58 were provided attached to each torque bar 32. In as much as two brake chambers provide about 3,500 lbs. of vertical support, a suspension system may be provided with a single diaphragm chamber assembly on each side such as that shown in FIG. 11 which suspension system may be utilized on trailers weighing, when fully loaded 3,500 lbs. However, only two bladders may be utilized on trailers which weigh up to 3,500 lbs. when fully loaded. Six bladders may be provided, such that there are three bladders attached to each torque bar for trailers which weigh 10,500 lbs. when fully loaded. Still further, eight diaphragm chamber assemblies may be provided, or four associated with each torque bar 32, for supporting trailers which weight 14,000 lbs. when fully loaded.

As can be seen, multiple configurations may be provided for use under trailers having varying weights. As can also be seen from the description of drawings 1-10, and the variation shown in FIG. 11, the configuration is simple and inexpensive to change as all that is required is the addition of multiple diaphragm chamber assemblies onto the existing frame 20. Still further, in as much as flexible bladder 86 is housed within upper chamber 76 and lower chamber 78, it remains relatively stable and does not require the extensive exterior linkages included with traditional air springs in order to maintain the position of the air spring relative to the axle and the trailer frame. Still further, the replacement of traditional air springs is relatively expensive. Conversely, replacement of the flexible bladder 86 within the diaphragm chamber assembly 58 is relatively inexpensive and may be completed using traditional hand tools and requires very little knowledge on the part of the mechanic. As such, the objective of the invention to provide a more economical air suspension for light and medium duty trailers is realized.

Accordingly, the improved “Independent Suspension For Light And Medium Duty Vehicles” apparatus is simplified, provides an effective, safe, inexpensive, and efficient device which achieves all the enumerated objectives, provides for eliminating difficulties encountered with prior devices, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the “Independent Suspension For Light And Medium Duty Vehicles” is constructed and used, the characteristics of the construction, and the advantageous new and useful results obtained; the new and useful structures, devices, elements, arrangements, parts, and combinations are set forth in the appended claims.

What is claimed:

1. A suspension system for use with a vehicle having a frame and a tire wheel assembly comprising:
a suspension frame rail;
at least one flexible bladder mounted to the frame rail and adapted to be mounted adjacent each side of the vehicle frame;
at least one torque bar extending adjacent to the suspension frame rail;
a flexible bladder pneumatic actuator operatively connected to the torque bar; and
a spindle adapted to receive a tire wheel assembly attached to the torque bar whereby movement of the spindle is reacted by the flexible bladder.

2. The suspension system as defined in claim 1 in which the flexible bladder is enclosed within a housing.

3. The suspension system as defined in claim 2 in which the housing is mounted to the suspension frame rail and in which the flexible bladder is attached to the housing.

4. The suspension system as defined in claim 3 in which a push rod extends between the torque rod and the bladder whereby rotation of the torque rod causes movement of the push rod.

5. The suspension system as defined in claim 4 in which rotation of the torque rod applies force to the flexible bladder.

6. The suspension system as defined in claim 5 in which a mounting clevis is rigidly attached to the torque rod and in which the push rod is moveably attached to the mounting clevis.

7. The suspension system as defined in claim 1 in which the torque rod is rotatably mounted to the suspension frame.

8. The suspension system as defined in claim 7 further comprising bearings, and in which a torque rod is mounted within the bearings to provide the rotational movement.

9. The suspension system as defined in claim 7 in which the torque rod is parallel to the suspension frame rail.

10. The suspension system as defined in claim 1 in which the flexible bladder is housed within a brake chamber.

11. The suspension system as defined in claim 10 in which there are two brake chambers attached to the suspension frame rail.

12. The suspension system as defined in claim 10 in which there are four brake chambers attached to the suspension frame rail.

13. The suspension system as defined in claim 10 in which there are six brake chambers attached to the suspension frame rail.

14. The suspension system as defined in claim 10 in which there are eight brake chambers attached to the suspension frame rail.

15. The suspension system as defined in claim 1 in which there are two flexible bladders.

16. The suspension system as defined in claim 1 in which there are four flexible bladders.

17. The suspension system as defined in claim 1 in which there are six flexible bladders.

18. The suspension system as defined in claim 1 in which there are eight flexible bladders.

19. The suspension system as defined in claim 1 in which the spindle has a central axis and the torque rod has a central axis and in which the torque rod central axis and the spindle central axis are offset.

20. The suspension system as defined in claim 19 in which the distance between the torque rod central axis and the spindle central axis is in the range of from 4 inches to 5 inches.

21. The suspension system as defined in claim 20 in which a spindle lever extends outwardly from the torque rod and is rigidly attached thereto, and in which the spindle is mounted to the spindle lever.

22. A method of supporting a load on a vehicle comprising the steps of:
providing a vehicle with a frame and a pair of tire wheel assemblies;
applying a force either upwardly or downwardly on the tire wheel assemblies;
transferring the force from the tire wheel assembly into a torque rod;
rotating the torque rod as a result of the force; and
reacting the torque rod in at least one brake chamber mounted to the frame.

23. The method as defined in claim 22 further comprising the step of supplying air to the brake chamber to react the force at the flexible bladder received from the torque rod.

24. The method as defined in claim 23 comprising the further step of transferring the force from the spindle to the spindle lever; transferring the force from the spindle lever to the torque rod; and transferring the force from the diaphragm to the torque rod.

25. The method as defined in claim 24 in which the spindle has a central axis and the torque rod has a central axis in which the spindle central axis and the torque rod central axis are offset relative to each other.

26. The method as defined in claim 25 in which the movement of the flexible bladders within the brake chamber is dampened with a shock absorber.

27. The method as defined in claim 22 in which there are multiple brake chambers.

28. The method as defined in claim 22 further comprising the steps of determining the amount of load to be carried by the vehicle and adjusting the number of brake chambers mounted to the frame to correspond to the total weight to the vehicle.
